(19) United States
(12) Patent Application Publication
(10) Pub. No.: US 2024/0139690 A1
(43) Pub. Date: May 2, 2024

(54) TRANSPARENT, GAS-PERMEABLE AND WATERPROOF FILM, PARTICULARLY FOR APPLICATIONS IN THE MEDICAL FIELD

(71) Applicants: ADHEX TECHNOLOGIES, Chenôve (FR); UNIVERSITE CLAUDE BERNARD LYON 1, Villeurbanne (FR); CENTRE NATIONAL DE LA RECHERCHE SCIENTIFIQUE, Paris (FR); UNIVERSITE JEAN MONNET SAINT ETIENNE, Saint Etienne (FR); INSTITUT NATIONAL DES SCIENCES APPLIQUÉES DE LYON, Villeurbanne (FR)

(72) Inventors: Alexane SEXTON, Villeurbanne (FR); Maud WILLIAMS, Dijon (FR); Julie JEVIC, Fauverney (FR); Eliane ESPUCHE, Villeurbanne (FR); Fabrice GOUANVE, SAINTE-FOY-LES-LYON (FR)

(21) Appl. No.: 18/384,567

(22) Filed: Oct. 27, 2023

(30) Foreign Application Priority Data
Oct. 31, 2022 (FR) 2211348

(51) Int. Cl. B01D 71/26; B01D 53/22; B01D 71/02

(52) U.S. Cl. CPC B01D 71/262; B01D 53/228; B01D 71/028; B01D 71/261; B01D 2325/04; B01D 2325/44

(57) ABSTRACT

A transparent, gas-permeable and waterproof film, particularly for applications in the medical field is disclosed. The film includes a polyolefin base, to which is added a monomeric plasticiser with a percentage by mass of between 10% and 50% and preferably also molecular sieves with a percentage by mass of less than or equal to 20%, this addition enables in particular the gas permeability of the film to be increased, said film thus having a high gas permeability, as well as low water permeability and high transparency, together with various mechanical characteristics and properties so that it is particularly well suited to many applications, in particular in the medical sector and in particular for application to an identification card used in the medical diagnosis.

### CROSS-REFERENCE TO RELATED APPLICATION(S)

This present claims priority to French Patent Application No. 2211348, filed Oct. 31, 2022, the disclosure of which is hereby incorporated by reference in its entirety.

### TECHNICAL FIELD

The present disclosure relates to a transparent, gas-permeable, and waterproof film, particularly for applications in the medical field.

### TECHNICAL BACKGROUND

Although not exclusively, the transparent, gas-permeable, and waterproof film is applied, more particularly, to an identification card used in an identification test used, in medical diagnostics, to identify bacteria.

In the field of medical diagnosis, the medical profession often relies on the results of bacterial identification tests and antibiograms to determine the most appropriate antibiotic treatment for a patient's pathology and to monitor the evolution of the resistance in these bacteria to the antibiotics. These identification tests enable the pathogen responsible for an infection to be determined quickly and reliably.

To carry out such identification tests, it is necessary to use identification cards. The identification cards are disposable and single-use can quickly and accurately identify a wide variety of clinically relevant species of bacteria and yeasts. Each identification card has micro-wells containing identification substrates. To carry out an identification test, the solution to be analysed is injected into channels on the identification card, then the whole assembly is placed in an incubator. The platelets are then analysed using a range of standard methods.

To protect the culture medium from external pollution, each identification card is sealed on both sides with a transparent adhesive film.

The transparent adhesive film used for this purpose must have strict particular characteristics, in particular:
sufficient permeability to gases (oxygen, carbon dioxide) to allow the bacterial growth and diagnosis;
low water permeability to limit evaporation from the growing medium;
high transparency for taking readings at defined wavelengths; and
particular mechanical characteristics to enable the films to be transformed without deforming them.

Polymethylpentene (PMP) films are generally used for such applications. However, these polymethylpentene films have fixed values for the above characteristics.

There is therefore an interest and a need to be able to modify the values of these characteristics of the film in order to adapt them more precisely to those actually required for the applications envisaged.

### SUMMARY

The purpose of this invention is to provide a transparent, gas-permeable, and waterproof film that can be used, in particular, in the above applications and to meet this need.

According to the disclosure, said film comprises a polyolefin base (matrix) to which is added at least one monomeric plasticiser with a percentage by mass of the monomeric plasticiser of between 10% and 50%, and preferably of between 15% and 45%.

In a preferred embodiment, said film also comprises molecular sieves with a percentage by mass of less than or equal to 20%, and preferably less than or equal to 10%.

In this way, the disclosure produces a film that has, in particular, as specified below, high permeability to gases (oxygen, carbon dioxide), low permeability to water (liquid) and high transparency, as well as various mechanical properties and characteristics. Depending on the proportion of elements (monomeric plasticiser, molecular sieve) added to the polyolefin base, the properties of the film can be modified and adapted to the properties required for the applications envisaged.

This film is particularly suitable for use on an identification card as described above. However, thanks to its surprising and advantageous characteristics, said film can also be used in many other applications, particularly but not exclusively in the medical field.

Advantageously, the polyolefin matrix corresponds to one of the following components: a PP homopolymer (made of polypropylene) or a PP/PE block or random copolymer (PP polypropylene and PE polyethylene).

In addition, it is advantageous that the monomeric plasticiser is dioctyl sebacate (DOS).

Also, the molecular sieves are advantageously made from at least one of the following materials: cyclodextrins (CD), zeolites, polyhedral oligomeric silsesquioxane (POSS), metal organic frameworks (MOF), covalent organic frameworks (COF).

In addition, in a particular embodiment:
the film has a thickness of between 25 μm and 100 μm; and/or
it is provided on at least one of its sides with a layer of adhesive so that it can be easily stuck to a support.

### BRIEF DESCRIPTION OF THE FIGURES

Other advantages and characteristics will become clearer from the following description of several non-limiting examples of a film according to the disclosure, referring, in particular, to the attached figures. In these figures, identical references designate similar elements.

FIG. 1 is a partial schematic cross-sectional view of a transparent, gas-permeable, and waterproof film according to a first embodiment of the disclosure.

FIG. 2 is a partial schematic cross-sectional view of a transparent, gas-permeable, and waterproof film according to a second preferred embodiment of the disclosure.

### DETAILED DESCRIPTION

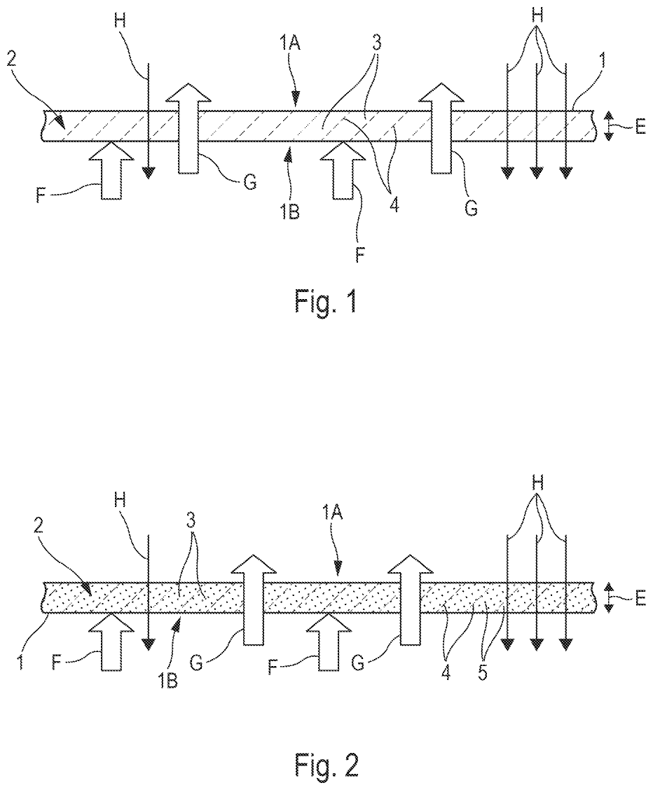

The film 1 used to illustrate the disclosure and shown in two different embodiments in FIGS. 1 and 2 is a transparent, gas-permeable, and waterproof film, as described below.

In the first embodiment shown in FIG. 1, the film 1 is formed from a material 2 comprising a polyolefin base (matrix) 3, illustrated schematically by a white background in FIGS. 1 and 2, and a monomeric plasticiser 4, illustrated schematically by dashed lines, which has been added (mixed) to the polyolefin base 3. The monomeric plasticiser 4 which is distributed (mixed), preferably uniformly, in the polyolefin base 3 has a percentage by mass which is between 10% and 50%, and preferably between 15% and 45% of the total mass of the material 2 of the film 1.

Furthermore, in the second embodiment (which is the preferred embodiment), the film 1 is also formed, as shown in FIG. 2, from a material 2 comprising a polyolefin base (matrix) 3, to which a monomeric plasticiser 4 is added. The monomeric plasticiser 4, which is distributed, preferably uniformly, in the polyolefin base 3, also has a percentage by mass of between 10% and 50%, and preferably between 15% and 45%, of the total mass of the material 2 of the film 1.

In this second (preferred) embodiment, the material 2 of the film 1 also comprises molecular sieves 5, illustrated schematically by black dots in FIG. 2. These molecular sieves 5 specified below are distributed, preferably uniformly, in the polyolefin base (matrix) 3 of the material 2. The molecular sieves 5 have a percentage by mass that is less than or equal to 20% and preferably less than or equal to 10% of the total mass of the material 2 of the film 1.

The addition of the monomeric plasticiser 4 and the molecular sieves 5 produces a surprising effect, in particular, in terms of (high) gas permeability, enabling advantageous characteristics to be obtained.

As explained below, the film 1 made from the material 2 has the following characteristics and advantages:
high transparency, as illustrated in FIGS. 1 and 2 by arrows H passing through the film 1, with a transmittance greater than 85% at 428 nm;
a low permeability to water (H₂O), less than 1.66E-12 mol·m/(m²·s·Pa) (or less than 5000 bar), as illustrated in FIGS. 1 and 2 by arrows F stopped by the film 1. For the purposes of this disclosure, a value denoted “xEy” is equal to “x*10^{y}”
a high permeability to carbon dioxide (CO₂), greater than 1.66E-14 mol·m/(m²·s·Pa) (or greater than 50 bar); and
a high oxygen O₂ permeability, greater than 3.35E-15 mol·m/(m²·s·Pa) (or greater than 10 bar).

These high gas permeabilities are illustrated in FIGS. 1 and 2 by arrows G passing through the film 1.

The film 1 made from the material 2 also has the following characteristics:
a strain at break of between 30% and 500%; and
a Young's modulus greater than 5.00E+07 Pa (or kg/(m·s2)).

These last characteristics make the film 1 flexible and easy to handle, and, in particular, sufficiently easy to handle for the applications envisaged.

In each of the formulation modes, the polyolefin matrix 3 corresponds to one of the following components:
a PP (polypropylene) homopolymer;
a PP/PE block or random copolymer (polypropylene PP and polyethylene PE).

The (starting) polyolefin matrix 3 enables, in particular for thicknesses E of film 1 of between 25 and 100 μm, the transparency criteria required for the applications envisaged to be met and to provide sufficient hydrophobicity to guarantee low water flows (in the liquid state).

In addition, the polyolefin matrix 3 can be easily melt-processed. A melt method is preferably used both for the various stages of formulating the material 2 and for shaping the film 1. Such a method has the particular advantage of having a low environmental impact with respect to a solvent phase method and is economically attractive from an industrial point of view. Preferably, any modifications made to the polymers used are carried out by a melt method.

In addition, the additives (the monomeric plasticiser 4 and the molecular sieves 5) incorporated into the polyolefin matrix 3 have sufficient thermal stability for the conditions of implementation by the melt method and enable a low permeability to water to be maintained.

A polyolefin matrix 3 as used in this disclosure thus has, in particular, the following characteristics and advantages:
high transparency;
waterproof;
mechanical properties: flexible and non-stretchable; and
the ability to be shaped by the melt method.

In addition, whatever the method used, the monomeric plasticiser 4 (comprising organic molecules with a low molar mass) added to the polyolefin matrix 3 is preferably dioctyl sebacate (DOS).

The addition of monomeric plasticiser 4 to the polyolefin matrix 3, without damaging the optical properties of the polyolefin matrix 3, increases its permeability to gases by plasticising the polymer chains of the polyolefin matrix 3.

To improve the gas permeability of the polyolefin matrix 3, low molar mass organic molecules are added, in particular, to increase the mobility of the polymer chains. An increase in the mobility of the latter, or more generally of the permeation medium, leads to an increase in permeability.

Furthermore, in said second (preferred) embodiment, the molecular sieves 5 that are added correspond to at least one of the following materials:
cyclodextrins (CD);
zeolites;
polyhedral oligomeric silsesquioxane (POSS);
metal organic frameworks (MOFs);
covalent organic frameworks (COFs).

In particular, the use of molecular sieves and, more specifically, zeolites (which have little effect on mechanical properties apart from the strain at break) is highly advantageous.

In the second embodiment, the gas permeability of the film 1 is greatly increased by the addition of both the monomeric plasticiser 4 and molecular sieves 5, while retaining sufficient mechanical and optical properties for the intended applications.

In a first embodiment, the molecular sieves 5 are all made of one and the same material, from among the aforementioned materials.

In addition, in a second embodiment, the material 2 comprises at least two different types of molecular sieve 5, a first type of which is made from a first material (among the aforementioned materials) and a second type of which is made from a second material (among the aforementioned materials) different from said first material.

In the present disclosure, the molecular sieves 5 have a percentage by mass of between 0% (first embodiment) and 20%, and preferably between 0% and 10%, of the total mass of the material 2 of the film 1.

The table below shows the main characteristics of the film 1 for four different formulations F1, F2, F3 and F4 of the material 2.

| | Elastic | Elastic | Stress | Elastic | Strain | O₂ | CO₂ | H₂O liquid | Transmittance |
|---|---|---|---|---|---|---|---|---|---|
| | modulus | stress | at break | strain | at break | permeability | permeability | permeability | at 428 nm |
| Formulation | (MPa) | (MPa) | (MPa) | (%) | (%) | (SI) | (SI) | (SI) | (%) |
| F1 | 146 | 12 | 12 | 32 | 271 | 4.45E−15 | 1.74E−14 | 7.76E−13 | 90 |
| F2 | 73 | 12 | 12 | 30 | 260 | 8.63E−15 | 2.26^{E}−14 | 8.88E−13 | 88 |
| F3 | 186 | 32 | 16 | 27 | 256 | 3.52E−15 | 1.809E−14 | 1.07E−12 | 89 |
| F4 | 179 | 10 | 13 | 30 | 286 | 4.32E−15 | 2.881E−14 | 6.56E−13 | 90 |

This table shows the values of at least some of the parameters considered for the different formulations F1, F2, F3 and F4.

In this table, the formulations F1 and F2 refer to the first embodiment (FIG. 1) comprising a mixture of polyolefin base 3 and monomeric plasticiser 4, and the formulations F3 and F4 refer to the second embodiment (FIG. 2) comprising a mixture of polyolefin base 3, monomeric plasticiser 4 and molecular sieves 5. Furthermore, in this case:
the polyolefin base 3 is a PP/PE copolymer of MFI 1 to 8;
the monomeric plasticiser 4 is DOS; and
the molecular sieves 5 are either zeolite NaY or zeolite NaX.

Specifically:
F1 relates to a blend of PP/PE copolymer and 25% DOS;
F2 relates to a blend of PP/PE copolymer and 35% DOS;
F3 relates to a blend of PP/PE copolymer, 18% DOS and 6% NaY; and
F4 relates to a blend of PP/PE copolymer, 21% DOS and 8% NaX.

This table highlights the following advantageous characteristics of the different formulations:
the high permeability to gases (oxygen O₂, carbon dioxide CO₂), expressed in the SI International System, i.e. in mol·m/(m²·s·Pa) [[ ]];
the low permeability to water H₂O in the liquid state, also expressed in mol·m/(m²·s·Pa) [[ ]];
the high transparency, i.e., transmittance at a wavelength of 428 nm, expressed as a percentage; and
specific mechanical characteristics, namely elastic modulus, elastic stress and stress at break expressed in MPa, and elastic strain and strain at break expressed in %.

The four formulations F1 to F4 all have good gas permeability properties. In addition, the formulations F3 and F4 have improved mechanical properties.

The following is an example of a process for manufacturing a film 1 such as that described above.

During this manufacturing method, first of all the polyolefin matrix 3 is melted.

Next, the components corresponding to the relevant production method are added to the molten polyolefin matrix 3, and the whole is mixed in a conventional mixer.

Thus, to manufacture the material 2 according to the first embodiment, the monomeric plasticiser 4 is added to the polyolefin matrix 3, and the whole is mixed.

In addition, to manufacture the material 2 according to the second embodiment, both the monomeric plasticiser 4 and the molecular sieves 5 are added to the polyolefin matrix 3, and the whole is mixed.

In this case, the monomeric plasticiser 4 and the molecular sieves 5 can be added simultaneously to the polyolefin matrix 3. The monomeric plasticiser 4 and the molecular sieves 5 can also be added successively to the polyolefin matrix 3, starting with the monomeric plasticiser 4 or the molecular sieves 5, depending on the manufacturing method envisaged.

The various stages (melting, mixing) in the manufacturing method are carried out in the usual way.

When the mixture is homogeneous, the material 2 obtained is transformed and shaped in the usual way, in the molten state, for example using an extrusion operation, to obtain the film 1 with the desired characteristics, in particular, in terms of thickness.

By way of illustration, for use on an identification card, the thickness E (FIGS. 1 and 2) of the film 1 may be between 25 μm and 100 μm.

As indicated above, such a melt manufacturing method (for manufacturing the material 2 and shaping the film 1) has in particular the advantage of having a low environmental impact compared with a solvent phase method and is economically attractive from an industrial point of view.

In a particular embodiment, a layer of adhesive (not shown) is applied in the usual way to at least one of the sides 1A and 1B of the film 1. The adhesive film 1 obtained in this way can then be easily stuck to a support for the intended application.

The film 1, as described above, is particularly well suited for use on an identification card, thanks to its following characteristics:
a permeability to gases (oxygen, carbon dioxide) that is sufficient to allow bacterial growth and diagnosis;
a permeability to (liquid) water that is sufficiently low to limit evaporation from the culture medium;
a transparency that is sufficiently high to allow readings to be taken at defined wavelengths; and
mechanical characteristics that allow the film to be transformed without deforming it.

The film 1, as described above, can also be used in many other applications, particularly (but not exclusively) in the medical sector and especially in the field of diagnostics. More generally, the film 1 can be used in all applications in which its advantageous characteristics, and in particular its high gas permeability (allowing gas exchange while providing water barrier properties), are required.

It is clear that the examples presented above are only specific illustrations, and in no way limit the fields of application of this disclosure. In addition, characteristics of some of these different examples may be combined with each other where appropriate, without departing from the scope of this disclosure.

1. A transparent, waterproof and gas-permeable film, comprises:
a material comprising a polyolefin base, to which is added at least one monomeric plasticiser with a percentage by mass of the monomeric plasticiser of between 10% and 50% of a total mass of the material of the transparent, waterproof and gas permeable film, wherein the polyolefin base corresponds to one of the following components: a PP homopolymer or a PP/PE block or random copolymer, and wherein the transparent, waterproof and gas permeable film has a transmittance greater than 85% at 428 nm.

2. The transparent, waterproof and gas permeable film according to claim 1,
wherein a percentage by mass of the monomeric plasticiser is between 15% and 45% of the total mass of the material of the transparent, waterproof and gas permeable film.

3. The transparent, waterproof and gas permeable film according to claim 1,
wherein the material of the transparent, waterproof and gas permeable film additionally comprises molecular sieves with a percentage by mass less than or equal to 20% of the total mass of the material.

4. The transparent, waterproof and gas permeable film according to claim 3,
wherein a percentage by mass of the molecular sieves is less than or equal to 10% of the total mass of the material of the transparent, waterproof and gas permeable film.

5. The transparent, waterproof and gas permeable film according to claim 1,
wherein the monomeric plasticiser includes dioctyl sebacate.

6. The transparent, waterproof and gas permeable film according to claim 3,
wherein the molecular sieves include at least one of the following materials: cyclodextrins, zeolites, polyhedral oligomeric silsesquioxane, metal organic frameworks, covalent organic frameworks.

7. The transparent, waterproof and gas permeable film according to claim 1,
wherein the transparent, waterproof and gas permeable film has a thickness (E) of between 25 μm and 100 μm.

8. The transparent, waterproof and gas permeable film according to claim 1,
wherein the transparent, waterproof and gas permeable file is provided on at least one of its sides with a layer of adhesive.
